(19) United States
(12) Patent Application Publication
(10) Pub. No.: US 2012/0293593 A1
(43) Pub. Date: Nov. 22, 2012

(54) PRINTING APPARATUS AND PRINTING METHOD

(75) Inventors: Takamitsu KONDO, Shiojiri-shi (JP); Toru TAKAHASHI, Azumino-shi (JP); Kazuyoshi TANASE, Matsumoto-shi (JP); Hiroshi WADA, Azumino-shi (JP)

(73) Assignee: SEIKO EPSON CORPORATION, Tokyo (JP)

(21) Appl. No.: 13/473,440

(22) Filed: May 16, 2012

(30) Foreign Application Priority Data
May 18, 2011 (JP) 2011-111650

(51) Int. Cl. B41J 2/01

(52) U.S. Cl. 347/102

(57) ABSTRACT

A printing apparatus includes a head section which discharges a first ink which is cured due to the irradiation of light and a second ink which is a clear ink which is cured due to the irradiation of light and an irradiation section which irradiates the light, wherein a first image is formed by the light being irradiated with regard to the first ink which is discharged onto the medium, a second image is formed by the light being irradiated with regard to the second ink which is discharged onto the first image and the medium, a region where the first image is formed is included in a region where the second image is formed, and the discharge amount of the second ink per unit region is equal to or less than the discharge amount of the first ink per unit region.

### BACKGROUND

1. Technical Field

The present invention relates to a printing apparatus and a printing method.

2. Related Art

A printing apparatus is known which performs printing of an image by landing liquid droplets (dots) on a medium by discharging a liquid such as ink from a head section. As the printing apparatus, for example, there is a printing apparatus which discharges photocurable ink (for example, UV ink) which is cured due to irradiation of light such as ultraviolet (UV) light or visible light. In a printing apparatus such as this, after the UV ink is discharged to the medium from a nozzle, light is irradiated onto UK ink dots which have been formed on the medium. Due to this, the UV ink dots are fixed onto the medium by curing (for example, JP-A-2000-158793).

Using the printing method of JP-A-2000-158793, a clear image is formed using clear (transparent) UV ink on a color image which is formed using color UV ink and it is possible to adjust the glossiness of the image by coating the color image. At this time, in order to economize on the discharge amount of the clear ink, it is desirable that the clear image be formed with the same shape as the color image in a region where the color image is formed.

However, it is difficult for the clear image to be formed without any deviation in a region where the color image is printed and there are cases where the color image and the clear image are formed in deviated positions. When deviation such as this occurs, a portion which is not overlapped with the clear image is generated in an edge portion of the color image and there is a state where the edge portion of the color image is able to be directly visually recognized.

Here, in the printing using the UV ink, a phenomenon (increased thickness phenomenon) may occur where the edge periphery of the printed image is particularly higher than another portion. Accordingly, when there is a state where the edge portion of the color image such as that described above is directly visually recognized, the printed image is recognized as thicker than in practice in a thicker portion in the edge periphery and this is a cause where the image quality deteriorates. On the other hand, when the discharge amount of the clear ink is too large, the image quality is also deteriorated in this case since the increased thickness phenomenon occurs in the edge portion of the clear image itself.

### SUMMARY

An advantage of some aspects of the invention is to form an image with excellent image quality where it is difficult for the increased thickness phenomenon to stand out when a clear image is formed on the image using UV ink.

According to an aspect of the invention, there is provided a printing apparatus including a head section which discharges a first ink which is cured due to the irradiation of light and a second ink which is a clear ink which is cured due to the irradiation of light and an irradiation section which irradiates the light, wherein a first image is formed by the light being irradiated with regard to the first ink which is discharged onto the medium, a second image is formed by the light being irradiated with regard to the second ink which is discharged onto the first image and the medium, a region where the first image is formed is included in a region where the second image is formed, and the discharge amount of the second ink per unit region is equal to or less than the discharge amount of the first ink per unit region.

The other characteristics of the invention will be made clear using the description of the specifications and the attached diagrams.

### BRIEF DESCRIPTION OF THE DRAWINGS

The invention will be described with reference to the accompanying drawings, wherein like numbers reference like elements.

FIG. 1A is an explanatory diagram of a printed image when a covering image is printed on a medium using UV ink. FIG. 1B is a graph of measurement values of the thickness in a region (edge periphery) shown by a dotted line in FIG. 1A.

FIG. 2A is a diagram where the printed image of FIG. 1A is viewed from above. FIG. 2B is an explanatory diagram of an appearance when light is mirror reflected at a portion of the printed image of FIG. 2A.

FIG. 3 is a diagram describing an example where a color image is printed to be overlapped by a clear image.

FIG. 4 is a diagram describing an example in a case where the discharge amount of clear ink is reduced when a color image is printed to be overlapped by a clear image.

FIG. 5 is a diagram describing an example in a case where a formation position of a color image and a formation position of a clear image are deviated when a color image is printed to be overlapped by a clear image.

FIG. 6 is a diagram describing an example in a case where the size of a clear image is adjusted to be optimal when a color image is printed to be overlapped by a clear image.

FIG. 7 is a diagram illustrating an example in a case where a position where a color image is formed and a position where a clear image is formed are deviated in FIG. 6.

FIG. 8 is a block diagram illustrating the overall configuration of a printer.

FIG. 9 is an outline side view representing the configuration of a printer.

FIG. 10A is a diagram describing the arrangement of a plurality of heads with short lengths in a color ink head and a clear ink head of a head unit. FIG. 10B is a diagram describing an appearance of nozzle rows which are respectively arranged on a lower surface of each of the heads with short lengths.

FIG. 11 is a diagram representing the overall flow of a printing process.

FIG. 12 is a diagram representing the flow of a process which is performed using a printer driver in a color image processing process.

FIG. 13 is a diagram representing the flow of a process which is performed using a printer driver in a clear image processing process.

FIG. 14 is a diagram describing an outline of a clear image formation region.

FIG. 15 is a diagram describing an example where the size of a clear image formation region is changed in a transport direction and a width direction.

### DESCRIPTION OF EXEMPLARY EMBODIMENTS

At least the items below will be made clear due to the specifications and the description of the attached diagrams.

A printing apparatus includes a head section which discharges a first ink which is cured due to the irradiation of light and a second ink which is a clear ink which is cured due to the irradiation of light and an irradiation section which irradiates light, wherein a first image is formed by the light being irradiated with regard to the first ink which is discharged onto the medium, a second image is formed by the light being irradiated with regard to the second ink which is discharged onto the first image and the medium, a region where the first image is formed is included in a region where the second image is formed, and the discharge amount of the second ink per unit region is equal to or less than the discharge amount of the first ink per unit region.

According to a printing apparatus such as this, it is possible to form an image with excellent image quality where it is difficult for the increased thickness phenomenon to stand out when a clear image is formed on the image using UV ink.

In the printing apparatus, it is desirable that the region where the second image is formed be a region which is wider than the region where the first image is formed to the extent of pixels on an outer edge section of the region where the first image is formed and a predetermined number of pixels which are adjacent on the outer side of the region.

According to a printing apparatus such as this, it is possible to optimize the discharge amount of the clear ink and print an image with high image quality since it is possible to form the clear image in a region which is wide to the extent that is the minimum necessary with regard to the color image which is printed.

In the printing apparatus, it is desirable that a transport section which transports the medium in a transport direction be provided, the first image and the second image be formed by the first ink and the second ink being discharged onto the medium from the head section which is fixed above the medium while the medium is being transported, and the difference between the region where the second image is formed and the region where the first image is formed be larger in the direction which intersects with the transport direction than in the transport direction.

According to a printing apparatus such as this, even in a case where there is a positional deviation of the nozzle or the like in a direction (medium width direction) which intersects with the transport direction of the medium in a line printer, it is possible to print an image with high image quality without any effect from a deviation such as this.

In the printing apparatus, it is desirable that the medium does not absorb liquid.

According to a printing apparatus such as this, it is possible to print an image with high image quality more effectively by using ink (for example, UV ink) which is cured due to the irradiation of light.

In addition, a printing method is made clear including forming of a first image by discharging a first ink which is cured due to irradiation of light onto a medium and irradiating light from an irradiation section and forming of a second image by discharging a second ink which is clear ink cured due to irradiation of light onto the first image and the medium and irradiating light from the irradiation section, where a region where the first image is formed is included in a region where the second image is formed and the discharge amount of the second ink per unit region is equal to or less than the discharge amount of the first ink per unit region.

### Concept

### Increased Thickness Phenomenon and Increased Thickness Feeling

Since a medium such as a plastic film has an attribute where it is difficult to absorb ink, there is the using of UV ink as a photocurable ink when performing printing on a medium such as this using an ink jet method. The UV ink is an ink with an attribute where there is curing when irradiated with light such as ultraviolet light. It is possible to perform printing even with regard to a medium which does not absorb liquid and which has no ink absorption layer (a medium with no ink absorbing properties) due to dots being formed by curing of the UV ink.

However, since the dots which are formed using the UV ink bulge on the surface of the medium, convexities and concavities are possible on the surface of the medium when the printed image is formed on the medium using the UV ink. Then, the printed image has thickness in a case where the printed image is a covering image.

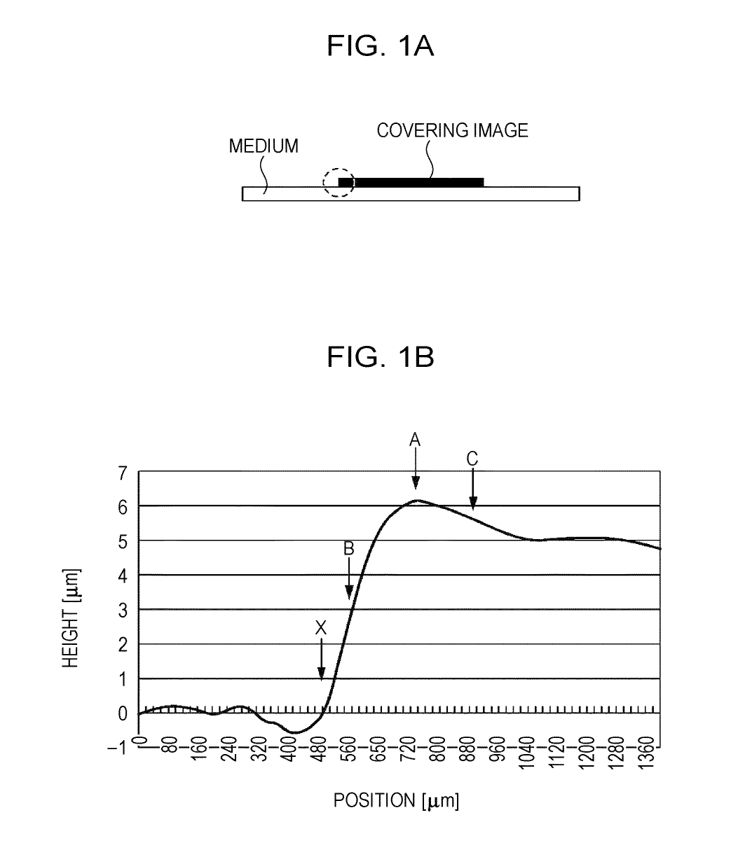

FIG. 1A is an explanatory diagram of a printed image when a covering image is printed on a medium using UV ink.

Since it is difficult for the UV ink to penetrate the medium, the dots are formed to be raised when the image is printed using the UV ink. When the covering image is printed, the printed image which has thickness is formed on the medium since the dots which are formed using the UV ink bury a predetermined region. For example, in a case where a character is printed on the medium, a character image which has thickness (the covering image) is formed on the medium. The thickness of the printed image which is printed using the UV ink is approximately several μm.

FIG. 1B is a graph of measurement values of thickness in a region (edge periphery) which is shown by a dotted line in FIG. 1A. The horizontal axis of the graph indicates the position of the medium and the vertical axis indicates the height of the dots (thickness of the printed image). Here, the printed image is a covering image where dots are formed with an ink amount of 10 ng and which covers with a printing resolution 720×720 dpi. The thickness of the printed image is measured using a non-stop CNC image measurement unit Quick Vision Stream plus manufactured by Mitutoyo Corporation. As shown in the diagram, the printed image has a thickness of approximately 5 μm.

A position X in the graph indicates a position which is the outermost side of the printed image. In other words, the position X indicates the position of the edge (contours) of the printed image. In addition, a position A in the graph indicates the thickest position (highest position) in the edge periphery of the printed image. In other words, the position A indicates the position of the bulging portion in the edge periphery of the printed image.

The position A is positioned at an inner side of approximately 200 μm from the position X. Between from the position X to the position A (a region B in the graph), there is an inclination so that the printed image is gradually thicker toward the inner side of the printed image. The vertical and horizontal scale in the graph do not match, but in practice, there is an inclination with an angle of less than 3° in the region B in the graph. In addition, in a region to the inner side of the position A in the printed image (a region C in the graph), the printed image is gradually thinner toward the inner side and is a substantially uniform thickness when the thickness reaches approximately 5 μm.

In the specifications of the invention, the phenomenon where the edge periphery is particularly raised more than other portions is referred to as an “increased thickness phenomenon” as shown in the position A in the graph. The increased thickness phenomenon is a unique phenomenon which is generated when an image is printed with an ink jet method using the UV ink.

The mechanism which generates the increased thickness phenomenon is not clear, but it is considered to be as follows. The UV ink has fluidity to the extent that it is able to be discharged from the nozzle with an ink jet method although the viscosity is high compared to ink with penetrating properties (in this manner, the point where fluidity is necessary to the extent that discharge is possible from the nozzle is a unique attribute which is different from ink which is used in press printing). The UV ink has fluidity until complete curing by irradiating ultraviolet rays after having landed on the medium. It is considered that the increased thickness phenomenon is generated in the edge periphery of the printed image due to the effect of the fluidity after landing.

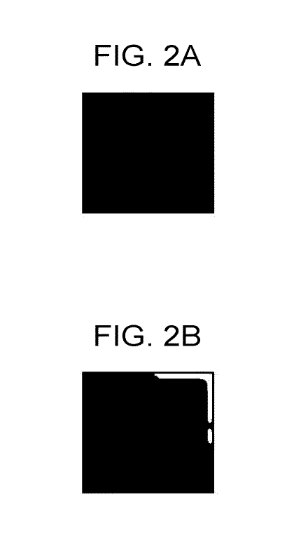

FIG. 2A is a diagram where the printed image of FIG. 1A is viewed from above. FIG. 2B is an explanatory diagram of an appearance when light is mirror reflected at a portion of the printed image of FIG. 2A. A portion which is visually recognized due to shining at an inner side of the printed image is shown as white in FIG. 2B.

In the central portion of the printed image, since the thickness is substantially the same, uniform glossiness is obtained. However, in the edge periphery of the printed image, since the thickness is not the same, uniform glossiness is not obtained.

In the edge periphery, the printed image does not have a uniform thickness and a bulging portion along the edge is formed along an inner side of the edge (contours) of the printed image due to the increased thickness phenomenon. As a result, there is visual recognition of a portion of the printed image shining along the edge as shown in FIG. 2B due to the state of the reflection angle of light. Due to the positional relationship and angle of the eyes of an observer, a light source, and the printed image, light which is mirror reflected at the inclined region in FIG. 1B enters the eyes of the observer and the printed image is visually recognized as shown in FIG. 2B.

As shown in FIG. 2B, when a portion of the printed image is viewed as shining along the edge, the entire printed image is perceived as three-dimensional. As an example, the printed image is perceived as three dimensional as when a three-dimensional object is displayed by the illumination of a portion of an object as a two-dimensional image being brighter in a display using computer graphics (for example, as when a three-dimensional object is displayed as a two-dimensional image using a ray tracing method). As a result, irrespective of there being a thickness of approximately 5 μm in practice, the observer of the printed image perceives a thickness equal to or more than this.

In the specifications, the perception that the printed image is thicker than in practice due to the increased thickness phenomenon is referred to as a “increased thickness feeling”. The issue of the “increased thickness feeling” is a unique issue which is generated when a covering image is printed with the ink jet method using the UV ink.

Here, there is hardly any thickness in the printed image using normal press printing (such as flexography or offset printing) compared to the printed image using the UV ink. As a result, in the printed image according to the normal press printing, the “increased thickness phenomenon” and “increased thickness feeling” do not occur. In addition, also in the printed image which is printed by ink penetrating the medium, there is any hardly thickness in the printed image. As a result, also in the printed image which is printed by ink penetrating the medium, the “increased thickness phenomenon” is not generated and “increased thickness feeling” does not occur. In this manner, the increased thickness phenomenon and the increased thickness feeling are a unique phenomenon and issue which are generated when an image is printed with an ink jet method using the UV ink.

### Concept of Embodiment

When printing is performed using the UV ink, as a method where the effect of the increased thickness feeling is reduced and an excellent image is printed, there is a method where a layer of clear ink is formed on a surface of the image by clear ink being discharged onto a printed image and the glossiness of the entire image is adjusted. That is, it is difficult for the increased thickness phenomenon which is perceived in the edge portion of the color image to stand out by forming a “clear image” to overlap a printed image (below, the printed image is conveniently referred to a “color image”).

Here, in the embodiment, clear ink is ink which is basically colorless and transparent. Here, there is no necessity to be completely colorless and transparent and indicates ink which is typically referred to as “clear ink” with no or a small amount of colorant being included. In addition, the color image described above is not limited to an image which is formed using only color ink and ink such as clear ink may be included.

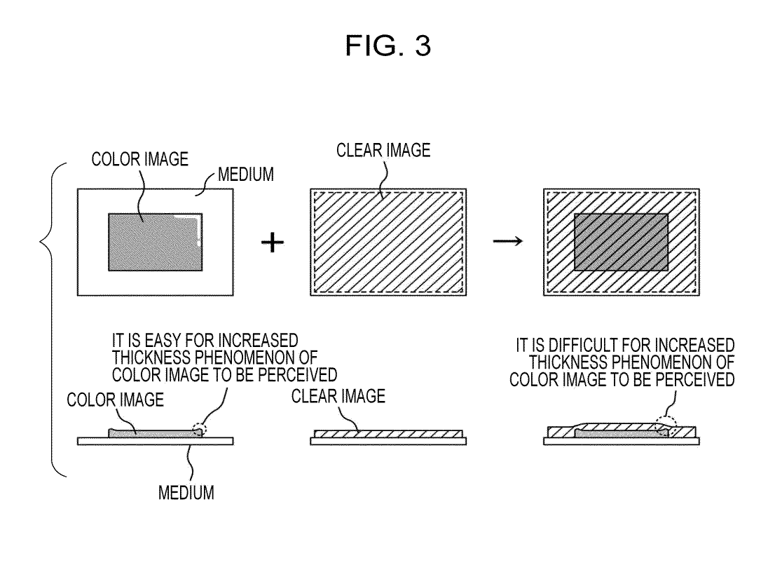

FIG. 3 is a diagram describing an example where a color image is printed to be overlapped by a clear image. The diagram on the left side of FIG. 3 represents an appearance of a color image which is formed on a predetermined region on a medium (colorized portion of the diagram). The diagram in the center of FIG. 3 represents a clear image which is to be formed to overlap the color image (portion in the diagram with the diagonal lines). Then, the diagram on the right side of FIG. 3 represents an appearance when the clear image is formed to overlap the color image in practice. In addition, cross-sectional diagrams, which schematically represent appearances of the images which are formed on the medium, are shown in the lower side of each of the diagrams.

In the color image which is formed on the medium, it is easy for the increased thickness phenomenon to be perceived at the vicinity of the edge portion as described above (the diagram on the left side of FIG. 3). On the other hand, an image is formed in a state where the entire surface of the color image is coated using the clear ink by the clear image being formed so as to cover the region where the color image is formed (the diagram on the right side of FIG. 3). It is difficult to see the concavities and convexities in the surface of the color image since the surface of the color image is entirely covered using the layer of the clear image. Due to this, it is difficult to also see the bulging portion in the edge periphery of the color image and it is difficult for the increased thickness feeling to be perceived.

Here, in the diagram on the lower right of FIG. 3, it is possible to see that a step has been generated in the clear image. However, as will be described later, it is possible that a step such as this is made so as not to stand out by mat adjustment of the clear image itself (frosting adjustment) due to adjustment of the ejection amount of the clear ink per unit region.

Here, when there is an attempt to form the clear image as shown in FIG. 3, the discharge amount of the clear ink is large. That is, in a case where the clear ink is discharged over the wide range of the medium as in FIG. 3, there is a problem in terms of cost since the usage amount of the clear ink is large. Accordingly, it is desirable that the discharge amount of the clear ink be reduced as much as possible when printing.

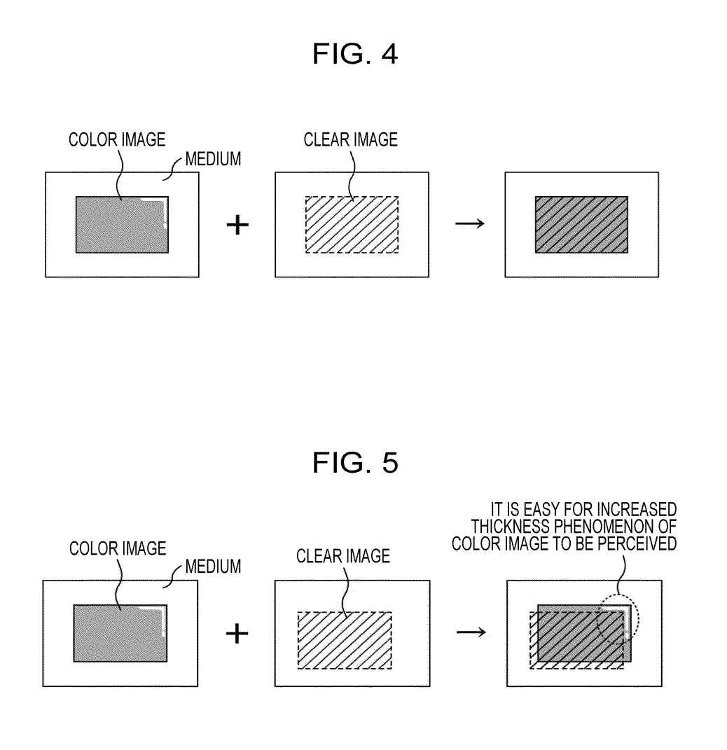

FIG. 4 is a diagram describing an example in a case where the discharge amount of the clear ink is reduced when the color image is printed to be overlapped by the clear image. In FIG. 4, the discharge amount of the clear ink is reduced by the region where the clear image is formed being minimized. In detail, the clear image which is exactly the same size as the color image is formed to overlap in the same region as the color image with regard to the region where the color image is formed. Due to this, the discharge amount of the clear ink is reduced and it is possible to make it difficult for the increased thickness feeling to stand out in the edge periphery of the color image.

However, it is difficult to form the clear image in the range which is exactly the same as the color image. For example, there are cases where there is deviation in the landing positions of the color ink dots and the clear ink dots when there is deviation in the head attachment positions (alignment deviation) between the color ink head which discharges the color ink and the clear ink head which discharges the clear ink or when the medium is not transported in a straight line during transportation. In these cases, there is a concern that the color image and the clear image are formed in positions which are deviated from each other.

FIG. 5 is a diagram describing an example in a case where the formation position of the color image and the formation position of the clear image are deviated when the color image is printed to be overlapped by the clear image. As shown in FIG. 5, a portion which is covered by the clear image and a portion which is not covered by the clear image are generated on the surface of the color image when the clear image is formed to be deviated from the color image. When deviation such as this occurs, it is easy for the increased thickness feeling to be perceived in a portion where the edge periphery of the color image is not covered by the clear image and it is not possible for an image with excellent image quality to be formed.

Therefore, in the embodiment, the size of the clear image which is formed to overlap the color image is adjustment in order that the discharge amount of the clear ink is suppressed and it is difficult for the increased thickness phenomenon of the color image to stand out.

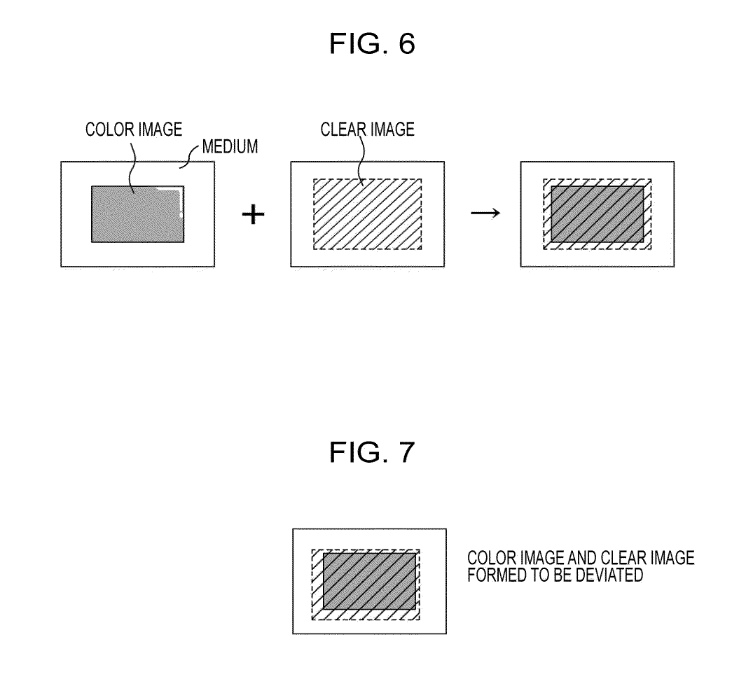

FIG. 6 is a diagram describing an example in a case where the size of the clear image is adjusted to be optimal when the color image is printed to be overlapped by the clear image. In addition, FIG. 7 is a diagram illustrating an example in a case where the position where the color image is formed and the position where the clear image is formed are deviated in FIG. 6.

In FIG. 6, the formation region of the clear image is adjusted so that the clear image is formed in a region which is slightly larger than the region where the color image is formed. Due to this, in the same manner as the case of FIG. 3, it is possible to suppress the increased thickness feeling in the edge periphery of the color image by the entire color image being covered by the clear image. In addition, even when there is deviation in the formation positions of the color image and the clear image as in FIG. 7, it is possible to maintain a state where the entirety of the color image is covered by the clear image by the clear image being formed to be larger than the color image. Accordingly, it is difficult for the increased thickness feeling to be perceived in the edge periphery of the color image.

In this manner, in the printing apparatus of the embodiment, the clear image is formed to overlap in an appropriate range with regard to the printed image (color image). That is, an image with excellent image quality where it is difficult for the increased thickness phenomenon to stand out is printed by printing being performed by the region where the color image is formed being included in the region where the clear image is formed.

### Basic Configuration of Printing Apparatus

A line printer (printer 1) will be described as an example as an embodiment of a printing apparatus which is used in the present embodiment.

### Configuration of Printer 1

The printer 1 is a printing apparatus which records an image by discharging a liquid such as ink toward a medium such as paper, cloth, or a film sheet. The printer 1 is a printer using an ink jet method, but the printer using the ink jet method may be an apparatus which adopts any discharging method if it is a printing apparatus where printing is possible by discharging ink.

An image is printed onto the medium in the printer 1 by UV ink described above being discharged. The UV ink is ink which includes resin which is cured by ultraviolet rays and is cured by a photopolymerization reaction occurring in the resin which is cured by ultraviolet rays when UV irradiation is applied. Here, the printing of an image is performed using color ink of the four colors of black (K), cyan (C), magenta (M), and yellow (Y) as the UV ink and clear ink (CL) which is colorless and transparent in the printer 1 of the embodiment.

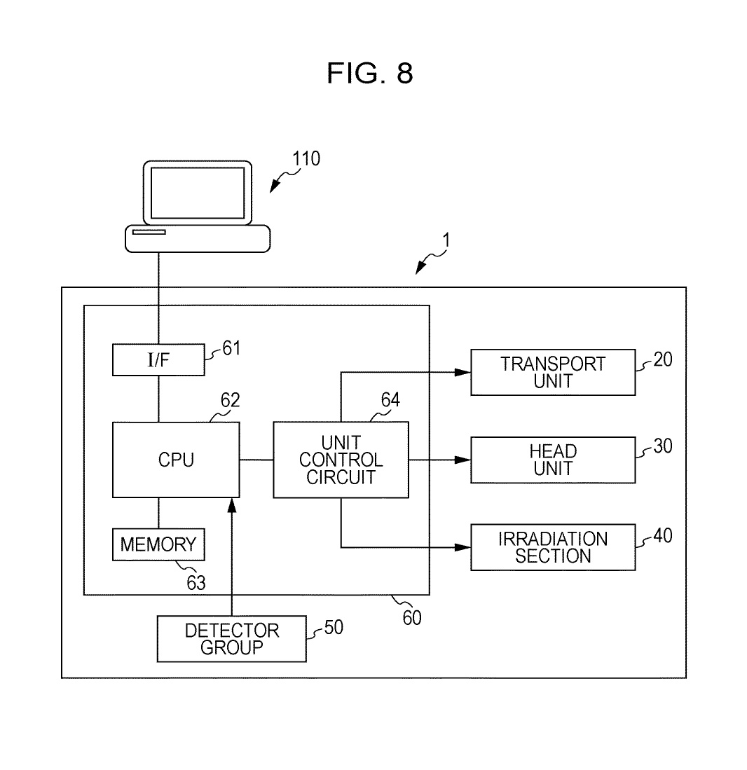

FIG. 8 is a block diagram illustrating the overall configuration of a printer 1. The printer 1 has a transport unit 20, a head unit 30, an irradiation unit 40, a detector group 50, and a controller 60. The controller 60 is a control section which controls each of the units such as the head unit 30 and the irradiation unit 40 based on printing data which is received from a computer 110 which is an external device. The circumstances in the printer 1 are monitored using the detector group 50 and the detector group 50 outputs the detection result to the controller 60. The controller 60 controls each of the units based on the detection result which is output from the detector group 50.

### Computer 110

The printer 1 is connected so as to be able to communicate with the computer 110 which is an external device. A printer driver is installed in the computer 110. The printer driver is a program which is for displaying a user interface on a display device and for converting image data which is output from the application program into printing data. The printer driver is recorded in a recording medium (a recording medium which is able to be read by a computer) such as a flexible disc FD or a CD-ROM. In addition, the printer driver is able to be downloaded to the computer 110 via the Internet. Here, the program is configured from code for realizing each type of function.

The computer 110 outputs the printing data to the printer 1 according to the image which is to be printed in order for the printer 1 to print the image. The printing data is data with a format which is able to be interpreted by the printer 1 and has various types of command data and pixel data. The command data is data for instructing the execution of specific actions to the printer 1. As the command data, there is, for example, command data which instructs the supply of the medium, command data which indicates the medium transport amount, and command data which instructs the medium discharge. In addition, the pixel data is data which is related to the pixels of the image which is to be printed.

Here, a pixel is a unit element which configures the image and the image is configured by the lining up of pixels in a two dimensional manner. The pixel data in the printing data is data (for example, gradient values) which relates to the dots which are formed on the medium (for example, paper S or the like). The pixel data is configured by, for example, data of two bits for each pixel. The pixel data of two bits is data which is able to express one pixel as four gradients.

### Transport Unit 20

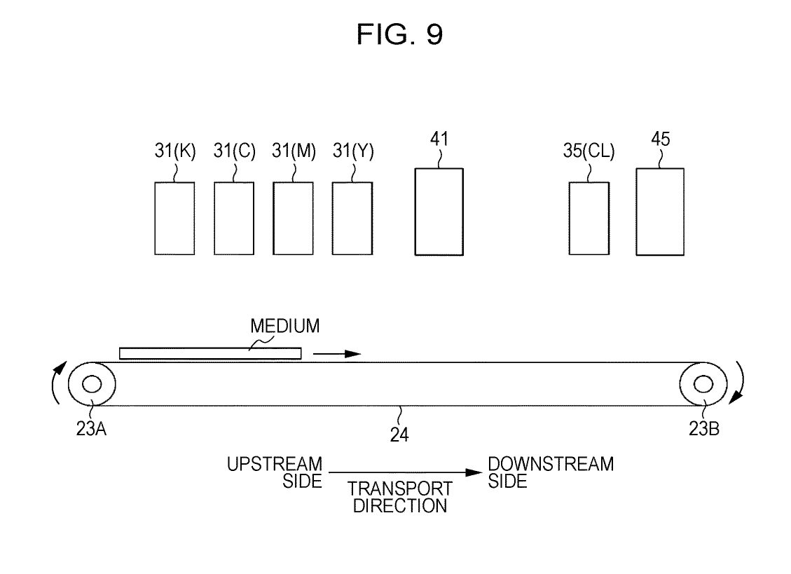

An outline side view representing the configuration of the printer 1 of the embodiment is shown in FIG. 9.

The transport unit 20 is for transporting the medium in a predetermined direction (referred to below as the transport direction). That is, the transport unit 20 relatively moves the medium with regard to the head unit 30 (which will be described later) which has been fixed. The transport unit 20 has a transport roller 23A on an upstream side in the transport direction, a transport roller 23B on a downstream side in the transport direction, and a belt 24 (FIG. 9). When a transport motor which is not shown is rotated, the transport roller 23A on the upstream side in the transport direction and the transport roller 23B on the downstream side in the transport direction rotate and the belt 24 is rotated. The medium which is supplied using medium feeding rollers (not shown) is transported to a region where printing is possible (a region which opposes the head unit 30 and the like which will be described later) by the belt 24. The medium which passes through the region where printing is possible is discharged to the outside by the belt 24. Here, the medium during transportation is electrostatically adsorbed or vacuum adsorbed to the belt 24.

### Head Unit 30

The head unit 30 is for discharging the UV ink to the medium. The head unit 30 forms ink dots by discharging each color of the color (KCMY) and clear (CL) ink with regard to the medium during transportation and prints the image on the medium. The printer 1 of the embodiment is a line printer and the head unit 30 is fixed above the medium which is transported (FIG. 9). Then, each of the heads of the head unit 30 is able to form dots to the extent of the width of the medium at one time.

As shown in FIG. 9, a color ink head 31 and a clear ink head 35 are provided in the printer 1 from the upstream side in the transport direction. The color ink head 31 is provided with a black ink head (K) which discharges black ink, a cyan ink head (C) which discharged cyan ink, a magenta ink head (M) which discharges magenta ink, and a yellow ink head (Y) which discharges yellow ink. Here, the color ink head 31 may be where nozzles which discharge each color of color ink of KCMY are provided in the same head. In addition, the arrangement order of the heads which discharge each color of color ink is arbitrary. In addition, other than the color ink of KCMY, clear ink for forming the image may be discharged from the color ink head 31.

The clear ink head 35 which discharges clear ink (CL) for forming the clear image is provided in the downstream side of the color ink head 31 in the transport direction.

Each of the heads are each configured from a plurality of heads with short lengths and each of the heads with short lengths are provided with a plurality of nozzles which are discharge outlets for discharging the UV ink.

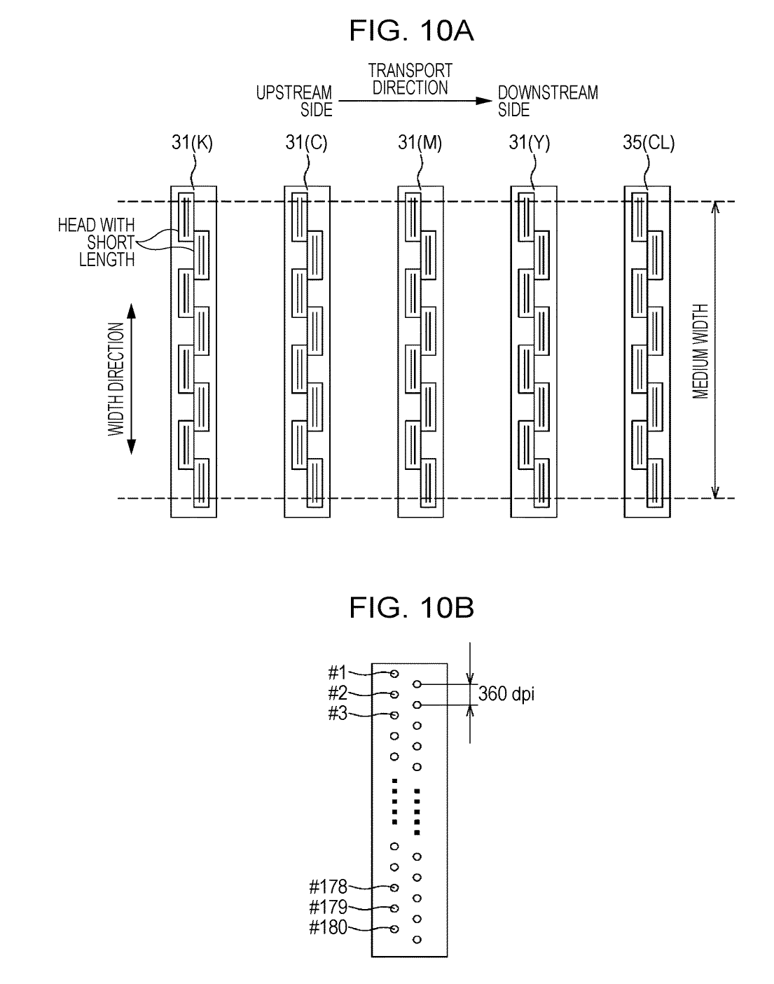

FIG. 10A is a diagram describing the arrangement of a plurality of heads with short lengths in the color ink head 31 and the clear ink head 35 of the head unit 30. FIG. 10B is a diagram describing an appearance of nozzle rows which are respectively arranged on a lower surface of each of the heads with short lengths. Here, FIG. 10A and FIG. 10B are diagrams where the nozzles are abstractly viewed from an upper surface.

In the color ink head 31, eight heads with short lengths are each lined up with a zigzag arrangement for each color along the width direction of the medium which is a direction which intersects with the transport direction of the medium. In the same manner, eight heads with short lengths are lined up in a zigzag arrangement also in the clear ink head 35. In the example of FIG. 10A, each of the heads is configured from eight heads with short lengths, but the number of heads with short lengths which configure each of the heads may be more than eight or may be less than eight.

A plurality of nozzles rows is formed for each of the heads with short lengths (FIG. 10B). The nozzle rows are each provided with 180 nozzles which discharge ink and the nozzles are lined up with a constant nozzle pitch (for example, 360 dpi) from #1 to #180 along the width direction of the medium. In a case of FIG. 10B, two rows of nozzle rows are lined up in parallel and the nozzles of each nozzle row are provided in positions which are each shifted by 720 dpi in the width direction of the medium. Here, the number of nozzles in one row is not limited to 180. For example, 360 nozzles may be provided in one row or 90 nozzles may be provided. In addition, the number of nozzle rows which are provided in each of the heads with short lengths is not limited to two rows.

In each of the nozzles, an ink chamber and a piezo element which is a piezoelectric element (neither of which are not shown) are provided. The piezo element is driven by a driving signal which is generated by a unit control circuit 64. Then, the ink chamber is compressed or expanded due to the driving of the piezo element and ink which has filled the ink chamber is discharged from the nozzle.

It is possible for ink droplets with a plurality of types of sizes with different amounts to be discharged from each nozzle using a pulse which is applied to the piezo element in accompaniment with the driving signal. For example, it is possible for three types of ink, which are formed from a large ink droplet with an amount which is able to form a large dot, a medium ink droplet with an amount which is able to form a medium dot, and a small ink droplet with an amount which is able to form a small dot, to be discharged from each of the nozzles. Then, each of the nozzles forms a dot line (raster line) along the transport direction of the medium by the discharging of the ink droplets intermittently from each of the nozzles with regard to the medium during transportation.

### Irradiation Unit 40

The irradiation unit 40 is for irradiating UV toward the UV ink dots which have landed on the medium. The dots which have been formed on the medium are cured by receiving UV irradiation from the irradiation unit 40. The irradiation unit 40 of the embodiment is provided with a color ink irradiation section 41 and a clear ink irradiation section 45.

The color ink irradiation section 41 is provided on the downstream side of the color ink head 31 in the transport direction (FIG. 9) and the color ink dots which are formed on the medium using the color ink head 31 are irradiated with UV for curing. The length of the width direction of the medium of the color ink irradiation section 41 is equal to or greater than the width of the medium. Here, there may be a configuration where there is a plurality of the color ink irradiation sections 41 and each are provided at the downstream side of the heads of each color of KCMY in the transport direction.

The clear ink irradiation section 45 is provided on the downstream side of the clear ink head 35 in the transport direction (FIG. 9) and the clear ink dots which are formed on the medium using the clear ink head 35 are irradiated with UV for curing. The length of the width direction of the medium of the clear ink irradiation section 45 is equal to or greater than the width of the medium.

In the embodiment, the color ink irradiation section 41 and the clear ink irradiation section 45 are provided with light emitting diodes (LED) as a light source of UV irradiation. It is possible for the LED to easily change the irradiation energy by controlling the size of the input current. The UV ink dots are cured to an optimal hardness by controlling the intensity of the UV irradiation. Here, the light source of the irradiation section 40 is separated from the color ink head 31 and clear ink head 35 due to being contained with the irradiation section 40. Due to this, UV which is irradiated from the light source is prevented from leaking to the lower surface of the color ink head 31 and the clear ink head 35, and as such, the generation of the clogging of nozzles and the like, which is due to the UV ink being cured in the vicinity of the openings of each of the nozzles which are formed at the lower surface thereof, is suppressed.

In addition, there may be a configuration where an irradiation section 47 (not shown) is further provided at the most downstream side in the transport direction and the UV ink dots may be cured with a process with two stages by UV being irradiated from the irradiation section 41 and 45 and the irradiation section 47. For example, UV is irradiated from the irradiation sections 41 and 45 with energy to the extent that the surface of the UV ink dots is cured (provisionally cured) and UV is irradiated from the irradiation section 47 at the final stage of the transportation with energy to the extent that the entirety of the UV ink dots are cured (completely cured). Due to this, the degree of curing of the UV ink dots is adjusted and the generation of a problem, where the landing position of the dots is deviated due to impacting of the UV ink dots with a high degree of curing, is suppressed when the UV ink dots are discharged from each of the heads. Detector Group

A rotary-type encoder (not shown), a medium detection sensor (not shown), and the like are included in the detector group 50. The rotary-type encoder detects the rotation amount of the transport roller 23A on an upstream side in the transport direction and the transport roller 23B on a downstream side in the transport direction. It is possible to detect the transport amount of the medium based on the detection result of the rotary-type encoder. The medium detection sensor detects the position of the front edge of the medium during feeding of the medium.

### Controller

The controller 60 is a control unit (control section) for performing control of the printer. The controller 60 has an interface section 61, a CPU 62, a memory 63, and a unit control circuit 64.

The interface section 61 performs transmission and reception of data between the computer 110 which is an external device and the printer 1. The CPU 62 is a computation processing device for performing control of the entirety of the printer 1. The memory 63 is for securing a region which stores a program of the CPU 62, an operation region, and the like and is configured by a storage element such as RAM or EEPROM. Then, the CPU 62 controls each of the units such as the transport unit 20 via the unit control circuit 64 in accompaniment with the program which is stored in the memory 63.

Action when Printing Images

An image printing action using the printer 1 will be simply described.

When the printer 1 receives the printing data from the computer 110, first, the controller 60 rotates the medium feeding roller (not shown) using the transport unit 20 and the medium which is to be printed upon is sent on the belt 24. The medium is transported at a constant speed on the belt 24 without stopping and passes by each of the units of the head unit 30 and the irradiation unit 40.

When the medium passes under the color ink head 31, the color ink (KCMY) is intermittently discharged with regard to the medium from each color of the ink heads of the color ink head 31 and color ink dots are formed on the medium. Then, UV is irradiated from the color ink irradiation section 41 at the downstream side of the color ink head 31 in the transport direction and the color image is printed by the color ink dots which are formed on the medium being cured and fixed.

Next, when the medium passes under the clear ink head 35, the clear ink is intermittently discharged onto the color image and the medium from the clear ink head 35 and clear ink dots are formed on the color image. Then, UV is irradiated from the clear ink irradiation section 45 at the downstream side of the clear ink head 35 in the transport direction and the clear image is printed by the clear ink dots which are formed on the color image being cured and fixed. In this manner, the image is printed on the medium.

Finally, the controller 60 discharges the medium where the printing of the image has been completed.

### Printing Process

A process which is performed in practice in the printer 1 when printing will be described.

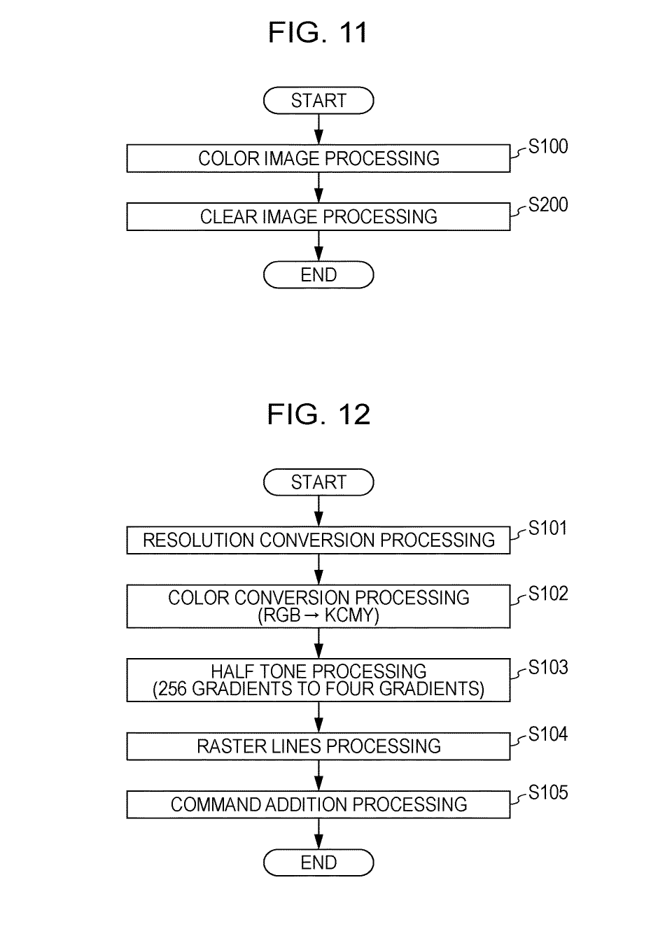

FIG. 11 is a diagram representing the overall flow of a printing process in the embodiment. In the embodiment, printing is performed by execution of a color image processing process where printing data for forming the color image is generated (S100) and a clear image processing process (S200) where printing data for forming the clear image on the color image which has been formed is generated.

### Color Image Processing

The printer driver of the computer 110 is activated when printing of an image which is drawn on an application program is instructed by the user of the printer 1. The printer driver receives data on the original image which is the printing target from the application program, converts to printing data with a format which is able to be interpreted by the printer 1, and outputs the printing data to the printer. When the original image data from the application program is converted to the printing data, the printer driver performs resolution conversion processing, color conversion processing, half tone processing, and the like. A diagram is shown in FIG. 12 which represents the flow of processing which is performed using the printer driver in the color image processing process (S100).

First, processing (resolution conversion processing) is performed when the original image data which is output from the application program (text data, image data, and the like)is converted to a resolution (printing resolution) for when printing onto the medium (S101). For example, in a case where the printing resolution is specified as 720×720 dpi, the image data with a vector format which is received from the application program is converted to image data with a bitmap format with a resolution of 720×720 dpi.

Here, each piece of pixel data in the image data after resolution conversion processing is RGB data with each gradient (for example, 256 gradients) which is represented by the RGB color space.

Next, color conversion processing where the RGB data is converted to data in the CMYK color space is performed (S102). The image data in the CMYK color space is data corresponding to the colors of ink which the printer has. The color conversion processing is performed based on a table (a color conversion lookup table LUT) where the gradient values of the RGB data and the gradient values of the CMYK data correspond.

Here, the pixel data after the color conversion processing is eight-bit CMYK data with 256 gradients which is representing by the CMYK color space.

Next, half tone processing is performed where data with a high number of gradients is converted to data with a number of gradients which is able to be formed by the printer (S103). For example, due to the half tone processing, the data which indicates 256 gradients is converted to one-bit data which indicates two gradients or two-bit data which indicates four gradients. In the half tone processing, a dither method, a y correction and error dispersion method, and the like is used. The data which has been half tone processed is the same resolution as the printing resolution (for example, 720×720 dpi). In the image data after the half tone processing, pixel data of one bit or two bits corresponds to each pixel and the pixel data is data which indicates the dot formation state for each pixel (presence or absent of a dot and the size of a dot).

After this, rasterize processing is performed where the pixel data which is lined up in a matrix formation is rearranged for each piece of pixel data in order of the data which is to be transferred to the printer 1 (S104). For example, the pixel data is rearranged according to the arrangement order of the nozzles in each of the nozzle rows.

A command addition processing is performed where command data is added to the data which has been rasterize lines processed according to the printing method (S105). As the command data, for example, there is transport data which indicates the transport speed of the medium and the like.

The printing data of the color image which is generated through the processing is transmitted to the printer 1 by the printer driver. Then, the ink of each color (KCMY color ink) is discharged in predetermined amounts from the color ink head 31 for the pixels which are specified in the printing data and an image (color image) is printed by a plurality of dots being formed on the medium.

Here, the configuration, which executes each type of processing in the printing process using the printer driver which is installed in the computer 110 in the example described above, has been described, but the printer driver may be installed in the controller 60 of the printer 1 and the processing may be performed by the printer 1.

### Clear Image Processing

Clear image processing is performed for forming the clear image using the printing data of the color image which is generated in the color image processing (S200).

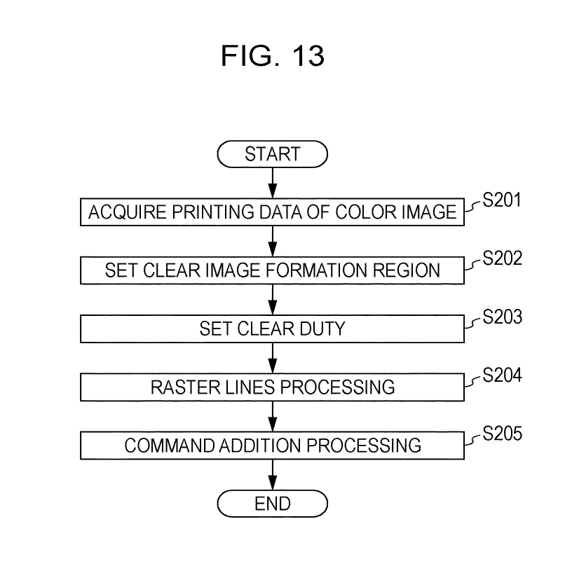

In the embodiment, the clear image itself which is formed is frosting adjusted (mat adjusted) so that the easiness of seeing the concavities and the convexities in the surface of the image due to the reflection of light is suppressed. The method where the clear image is mat adjusted is performed by adjusting the discharge amount of the clear ink. Below, the formation of the clear image will be described. A diagram is shown in FIG. 13 which represents the flow of processing where the clear image processing process is performed by the printer driver.

First, the printer driver acquires the printing data of the color image after the half tone processing (S103) in the color image processing process as the data for the clear image processing (S201). In the clear image processing, data for discharging clear ink is generated based on the data.

Next, a region which is to be where the clear image is formed is set using the color image data after the half tone processing (S202). As described before, in the embodiment, there is a demand for the discharge amount of the clear ink to be reduced as much as possible and for it is be difficult to perceive the increased thickness phenomenon which is generated in the edge periphery of the color image. As a result, it is necessary that the printing region of the clear image which is formed to overlap the color image is larger (wider) than the printing region of the color image and it is desirable that the printing region of the clear image be not too large. Therefore, the data is generated as the clear image printing data where the clear ink is discharged to a region which is wider by several pixels than the region (pixels) where the color ink is discharged.

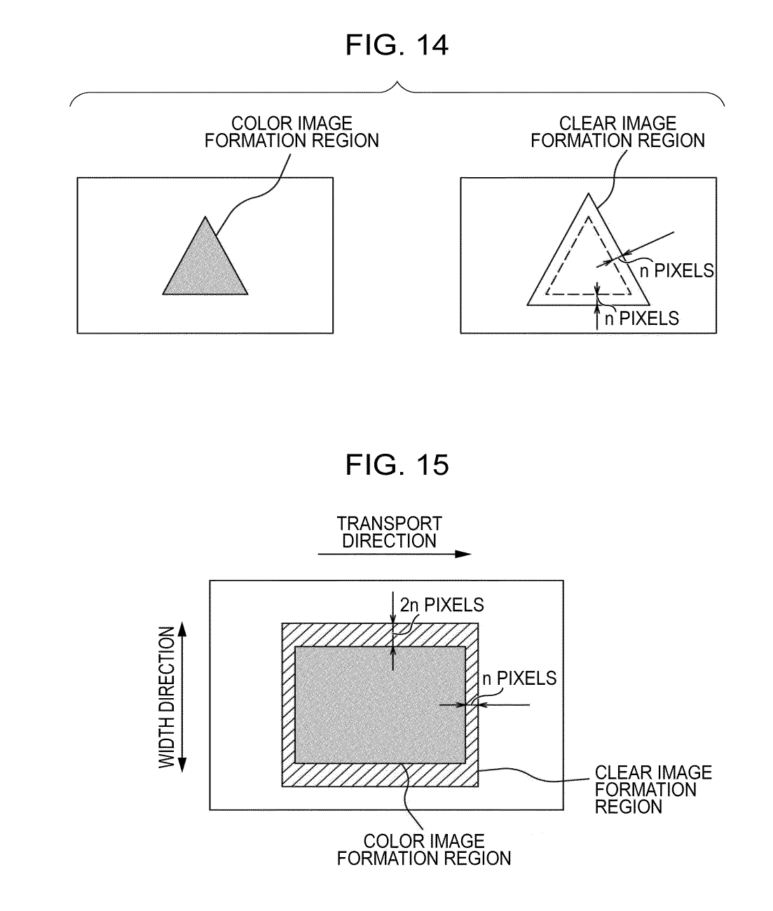

A diagram is shown in FIG. 14 which described the concept of the clear image formation region. In the color image processing (S100) described above, the color image formation region (the pixels where the color ink is discharged) is set as shown in the diagram on the left side of FIG. 14. In this case, as shown in the diagram on the right side of FIG. 14, the clear image formation region (the pixels where the clear ink is discharged) is set to a region which is wider than the pixels on the outer edge portion (the dashed line portion of the diagram) of the color image which has been set by a further n pixels. Due to this, the clear image formation region is set so as to include the color image formation region. Here, the value of n is initially stored in the memory 63 or the like. In addition, when the value of n is able to be changed by the user themselves, it is easy for an image with image quality according to the preferences of the user to be printed.

In this process, in order to set the clear image formation region, first, the position of the pixels at the outer edge portion of the color image (referred to below as the color edge pixels) are detected. Then, all of the pixels in an inner portion of the color edge pixels and the pixels of n pixels on the outer side of the color edge pixels are set as the clear image formation region. In other words, the clear image formation region is set to be wider than the color image formation region by n pixels which are adjacent to the pixels on the outer edge portion of the region where the color image is formed at the outer side of the region. The detection of the color edge pixels is able to be performed by the application of a Laplacian filter, a sobel filter, or the like which are common knowledge with regard to each color of pixel data in the color image after the half tone processing (S103) in the color image processing (or each KCMY color of pixel data with 256 gradients after color conversion (S102)). Then, n pixels of the pixels which are adjacent on the outer side are specified with regard to the color edge pixels which have been detected.

Here, in the printer which is a line head type such as the printer 1, there is a possibility that deviation in the landing position of the ink dots occurs in both directions of the transport direction of the medium and the width direction of the medium. For example, in a case where there is a bias in the transport rollers 23A and 23B in the transport unit 20, it is possible to consider that it is easy for the color image and the clear image to be deviated in the transport direction since the transport amount of the medium is no longer constant. In this case, it is possible to correction the deviation to a certain extent by adjusting the transport amount of the medium or adjusting the discharge timing of the ink.

On the other hand, in a case where the color image and the clear image are deviated in the width direction due to alignment deviation of both of the heads such as described above or meandering during the transportation of the medium, it is difficult to correct the deviation of the images which occurs in the width direction even if the transport amount of the medium or the ink discharge timing is adjusted.

Therefore, in the setting of the clear image formation region as described above, the discharge region of the clear ink is set to be wider in the width direction than in the transport direction. FIG. 15 is a diagram describing an example where the size of the clear image formation region is changed in the transport direction and the width direction. In a case where the formation region of the clear image is wider by n pixels in the transport direction with regard to the formation region of the color image as shown in the diagram, the pixels in the width direction are set to be more than the pixels in the transport direction such as being wider by 2 n pixels in the width direction. In other words, the clear image formation region is set so that the difference between the clear image formation region and the color image formation region is larger in the width direction than in the transport direction. For example, when the formation region of the clear image is set to be wider by five pixels in the transport direction compared to the formation region of the color image, the formation region of the clear image is set to be wider by ten pixels in the width direction.

Due to this, even in a case where the color image and the clear image are formed to be deviated in the width direction, it is easier for the clear image to be formed on the edge portion (the edge portion in the width direction of the medium) of the color image and it is easier to further suppress the perception of the increased thickness phenomenon.

In addition, there may be a method where the region where clear ink is discharged is determined by regions with a plurality of types of sizes and shapes (clear image formation regions) being stored in advance in the memory 63 and the printer driver appropriately selecting a region which is optimal. For example, it is possible that there is a method where a plurality of types of square regions such as with lengths on one side of 50 pixels, 100 pixels, and 150 pixels are provided, the pixels from among these which are to form the color image are completely included, and the region where the area is minimized is selected.

After the clear image formation region is set, the setting of the clear duty is performed (S203). Here, the clear duty refers to the amount of clear ink which is ejected per unit region of the medium. That is, the clear duty refers to the clear ink discharge amount for forming the clear image. Here, the printing data of the clear image is data of simple gradation with regard to the entire region.

As described above, the clear image is formed so as to be frosting adjusted (mat adjusted) in the embodiment. As an example of the method where the clear image with mat adjustment is formed, there is a method where the amount of the clear ink which is discharged onto the medium is adjusted. In detail, the density of the clear ink dots which are formed on the medium is reduced by the clear duty being reduced.

In a case where the density of the clear ink dots which are formed on the medium is high, there is a state where the medium is buried by the clear ink dots and the medium is covered by the clear ink in a film form. That is, it is easy for the light which is incident on the surface of the image to be mirror reflected since the surface of the clear image is similar to a mirror. On the other hand, in a case where the density of the ink dots is low, the light which is incident on the surface of the image is reflected in various directions on the surface of each of the dots and becomes scattered light since each of the individual dots are scattered on the medium. Accordingly, it is possible to mat adjust the clear image by reducing the amount of clear ink which is discharged per unit region (the clear duty).

In addition, it is possible to suppress the generation of the increased thickness phenomenon in the edge periphery of the clear image itself by mat adjustment of the clear image.

Therefore, in the embodiment, the size of the clear duty is appropriately adjusted by setting the value of the clear duty so that the clear duty is equal to or less than the color duty. The CPU 62 determines the average value of the duty in terms of each color of ink by referencing each color (KCMY) of the color image data after the half tone processing (S103). The overall discharge amount of the color ink per unit region (the color duty) is determined by totaling the duty in terms of each color. Then, the clear duty is calculated by multiplying a constant k to the color duty which has been calculated. The constant k is an arbitrary number where 0<k≦1 and is stored in the memory 63. In addition, it may be possible for the user to change the value of k during printing.

Due to this, the clear duty is equal to or less than the color duty, the overall printed image is appropriately mat adjusted, and it is possible that it is difficult for the increased thickness feeling to stand out in the edge periphery of the color image. Here, in the method described above, in a case where the color duty of the printed image is an extremely high value, the clear duty becomes a comparatively high value. In this case, since the ejection amount of the clear ink per unit region is large, the layer of the clear image is thick and there is a possibility that the increased thickness phenomenon occurs in the edge periphery of the clear image which is formed. However, it is possible that the increased thickness feeling is suppressed in the edge periphery of the color image even in a case such as this, and the issue of forming an image with excellent image quality where it is difficult for the increased thickness phenomenon to stand out is realized.

After this, in the same manner as the case of the color image processing, the rasterize processing (S204) and the command addition processing (S205) are executed. The clear image processing is completed.

Then, the printing of the clear image is performed in practice according to the printing data of the clear image which has been generated. The clear ink is discharged with a predetermined discharge amount according to the clear duty which is calculated in S203 and the clear image is formed to overlap the color image with regard to the clear image formation region which is set in S202.

### Overview

In the printer 1 of the embodiment, first, the color image (the first image) is formed by the color ink dots being formed due to the discharging of color UV ink from the color ink head to the medium and by curing due to the UV irradiation. Subsequently, the clear image (the second image) is formed on the color image by the clear ink dots being formed due to the discharging of the clear UV ink from the clear ink head onto the color image and the medium and by curing due to the UV irradiation. At this time, the region where the color image is formed is included in the region where the clear image is formed. In addition, the discharge amount of the clear UV ink per unit region is equal to or less than the discharge amount of the color UV ink per unit region.

The entirety of the color image, in particular the edge portion thereof, is covered using the clear image and it is difficult for the increased thickness phenomenon which is generated in the edge periphery of the color image to stand out. Furthermore, due to the adjustment of the per unit region discharge amount of the clear UV ink, the entirety of the image is mat adjusted and it is possible that it is more difficult for the increased thickness feeling in the color image to be perceived. Due to this, an image with excellent image quality is formed.

### Other Embodiments

The printer and the like have been described as one embodiment, but the embodiment described above is so that it is easy to understand the invention and it is not to be interpreted as limiting the invention. It is needless to say that modifications and alterations are possible which is not depart from the gist of the invention and equivalents are included in the invention. In particular, even the embodiments which are described below are included in the invention.

### Printing Apparatus

In each of the embodiments described above, the printer has been described as one example of the printing apparatus, but the invention is not limited to this. For example, technology in the same manner as the embodiment may be applied to various types of printing apparatuses where ink jet technology is applied such as color filter manufacturing devices, dyeing devices, precision processing devices, semiconductor manufacturing devices, surface processing devices, three-dimensional molding devices, liquid vaporization devices, organic EL manufacturing devices, (in particular, polymer EL manufacturing devices), display manufacturing devices, film-forming devices, and DNA chip manufacturing devices.

### Nozzle Row

In the embodiment described above, an example has been described where an image is formed using the four colors of KCMY and clear ink, but the invention is not limited to this. For example, the recording of the image may be performed using ink with color other than KCMY and CL such as light cyan, light magenta, and white.

In addition, the arrangement order of the nozzle rows in the head section is arbitrary. For example, the order of the nozzle rows of K and C may be swapped and there may be a configuration where the number of nozzle rows with K ink is larger than the number of nozzle rows with the other ink.

### Piezo Element

In each embodiment described above, a piezo element PZT is illustrated as the elements which performs the action for discharging the liquid, but it may be another element. For example, a heater element or an electrostatic actuator may be used.

The entire disclosure of Japanese Patent Application No. 2011-111650, filed May 18, 2011 is expressly incorporated by reference herein.

What is claimed is:

1. A printing apparatus comprising:
a head section which discharges a first ink which is cured due to the irradiation of light and a second ink which is a clear ink which is cured due to the irradiation of light; and
an irradiation section which irradiates the light,
wherein a first image is formed by the light being irradiated with regard to the first ink which is discharged onto the medium,
a second image is formed by the light being irradiated with regard to the second ink which is discharged onto the first image and the medium,
a region where the first image is formed is included in a region where the second image is formed, and
the discharge amount of the second ink per unit region is equal to or less than the discharge amount of the first ink per unit region.

2. The printing apparatus according to claim 1,
wherein the region where the second image is formed is a region which is wider than the region where the first image is formed to the extent of a predetermined number of pixels on an outer edge section of the region where the first image is formed and a predetermined number of pixels which are adjacent on the outer side of the region.

3. The printing apparatus according to claim 1, further comprising:
a transport section which transports the medium in a transport direction,
wherein the first image and the second image are formed by the first ink and the second ink being discharged onto the medium from the head section which is fixed above the medium while the medium is being transported, and
the difference between the region where the second image is formed and the region where the first image is formed is larger in the direction which intersects with the transport direction than in the transport direction.

4. The printing apparatus according to claim 1,
wherein the medium does not absorb liquid.

5. A printing method comprising:
forming a first image by discharging a first ink which is cured due to irradiation of light onto a medium and irradiating light from an irradiation section; and
forming a second image by discharging a second ink which is clear ink cured due to irradiation of light onto the first image and the medium and irradiating light from the irradiation section,
wherein a region where the first image is formed is included in a region where the second image is formed, and
the discharge amount of the second ink per unit region is equal to or less than the discharge amount of the first ink per unit region.
